(19) United States
(12) Patent Application Publication
(10) Pub. No.: US 2014/0021379 A1
(43) Pub. Date: Jan. 23, 2014

(54) OPTICAL CONNECTOR HAVING ALIGNMENT PORTIONS

(71) Applicant: CHEN-YU YU, Tu-Cheng (TW)

(72) Inventor: CHEN-YU YU, Tu-Cheng (TW)

(21) Appl. No.: 13/663,370

(22) Filed: Oct. 29, 2012

(30) Foreign Application Priority Data
Jul. 23, 2012 (TW) 101126524

(51) Int. Cl. G01J 1/42

(52) U.S. Cl. 250/578.1; 250/216

(57) ABSTRACT

An optical connector, includes a circuit board, at least one light emitter, at least one light receiver, and a transparent shell. The circuit board includes a mounting surface and an alignment portion formed on the mounting surface. The at least one light emitter and at least one light receiver are mounted on the mounting surface. The shell includes at least two lenses and an alignment portion. The alignment portion of the circuit board is engaged with the alignment portion of the shell, with each of the at least one light emitter and the at least one light receiver being aligned with a respective one of the at least two lenses.

### BACKGROUND

1. Technical Field

The present disclosure relates to optical connectors, and particularly to an optical connector having aligning portions.

2. Description of Related Art

An optical connector includes a circuit board, a number of light emitters, a number of light receivers, and a shell. The light emitters and the light receivers are mounted on and electrically connected to the circuit board. The shell includes a number of lenses and is adhered to the circuit board by adhesive. Each of the light emitters and light receivers is precisely aligned with a corresponding lens. In use, light beams emitted by each light emitter project into the shell through the corresponding lens and then emit out from the shell. External light beams project into the shell, pass through the corresponding lenses, and then project to the respective light receivers. However, because the shell is adhered to the circuit board, the shell may float away the required position before the adhesive is cured, resulting in that the light emitters and the light receivers misalign with the respective lenses.

What is needed therefore is an optical connector addressing the limitations described.

### BRIEF DESCRIPTION OF THE DRAWINGS

FIG. 1 is an exploded view of an optical connector, according to an exemplary embodiment.

FIG. 2 is a top view of the optical connector of FIG. 1, when the optical connector is assembled.

FIG. 3 is a cross-sectional view of the optical connector of FIG. 2, taken along line

FIG. 4 is a cross-sectional view of the optical connector of FIG. 2, taken along line IV-IV.

### DETAILED DESCRIPTION

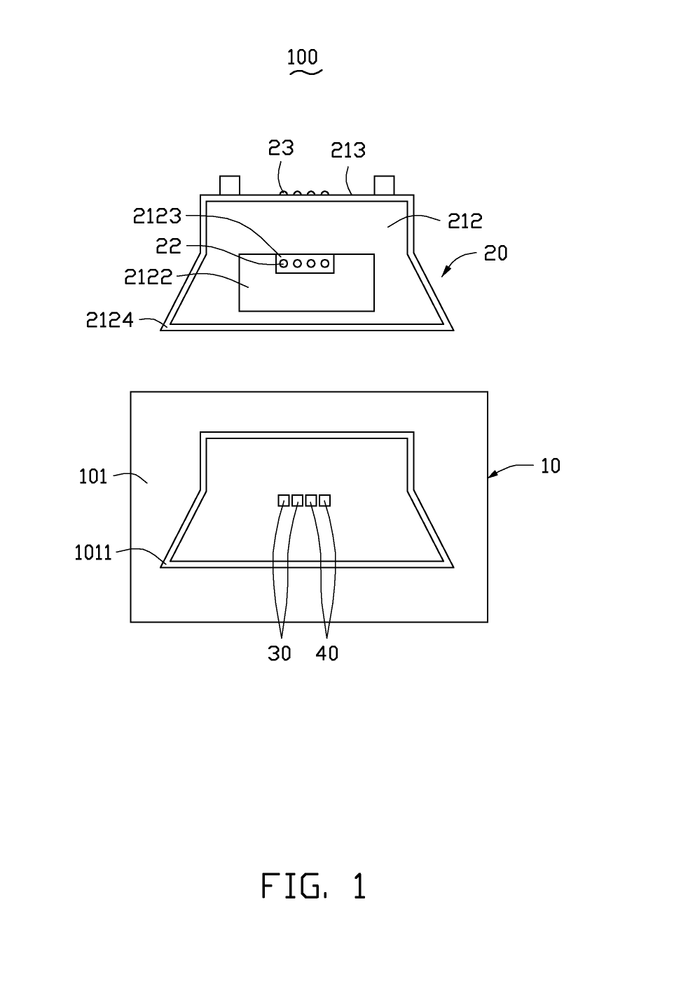

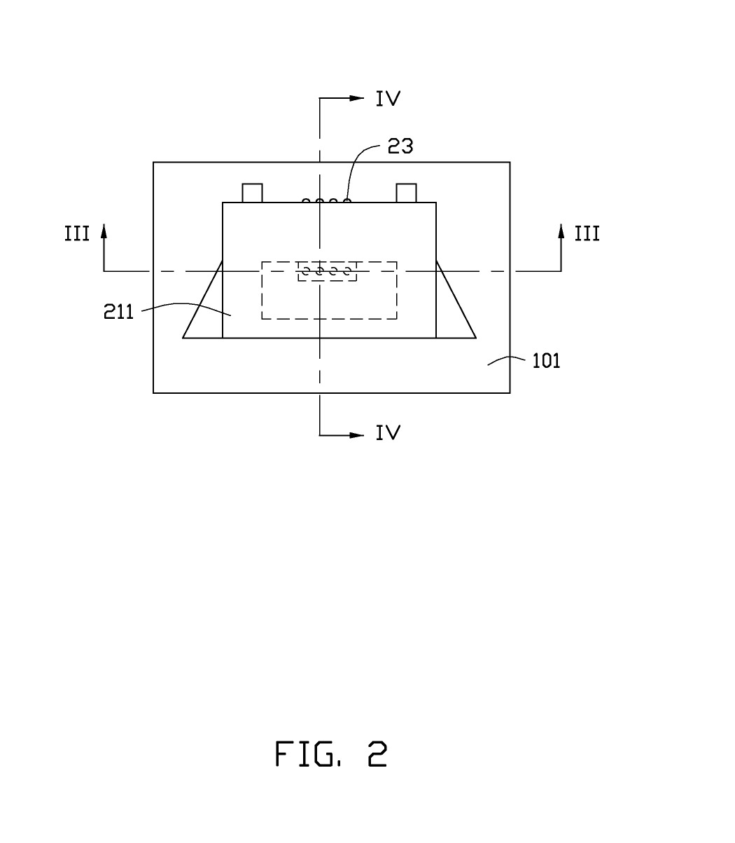

Referring to FIGS. 1, 2, and 4, an optical connector 100, according to an exemplary embodiment, is shown. The optical connector 100 includes a circuit board 10, a shell 20, at least one light emitter 30, at least one light receiver 40, and at least two reflecting elements 50.

The circuit board 10 includes a mounting surface 101. The at least one light emitter 30 and the at least one light receiver 40 are mounted on the mounting surface 101 and electrically connected with the circuit board 10. The at least one light emitter 30 and the at least one light receiver 40 are distributed in a line. In the embodiment, the numbers of the light emitters 30 and the light receivers 40 are two, respectively. Each light emitter 30 is a laser diode (LD) for emitting light beams. Each light receiver 40 is a photodiode (PD) for receiving light beams. The circuit board 10 forms an alignment portion 1011 on the mounting surface 101. In the embodiment, the alignment portion 1011 is a closed groove surrounding the light emitters 30 and the light receivers 40. A shape of the closed groove is generally trapezoidal. A shape of a cross plane of the closed groove perpendicular to the mounting surface 101 is rectangular.

The shell 20 is made of transparent plastic and includes a main portion 21, at least two first lenses 22, and at least two second lenses 23. The main portion 21 includes a top surface 211, a bottom surface 212 opposite to the top surface 211, and a side surface 213 perpendicularly connecting the top surface 211 and the bottom surface 212.

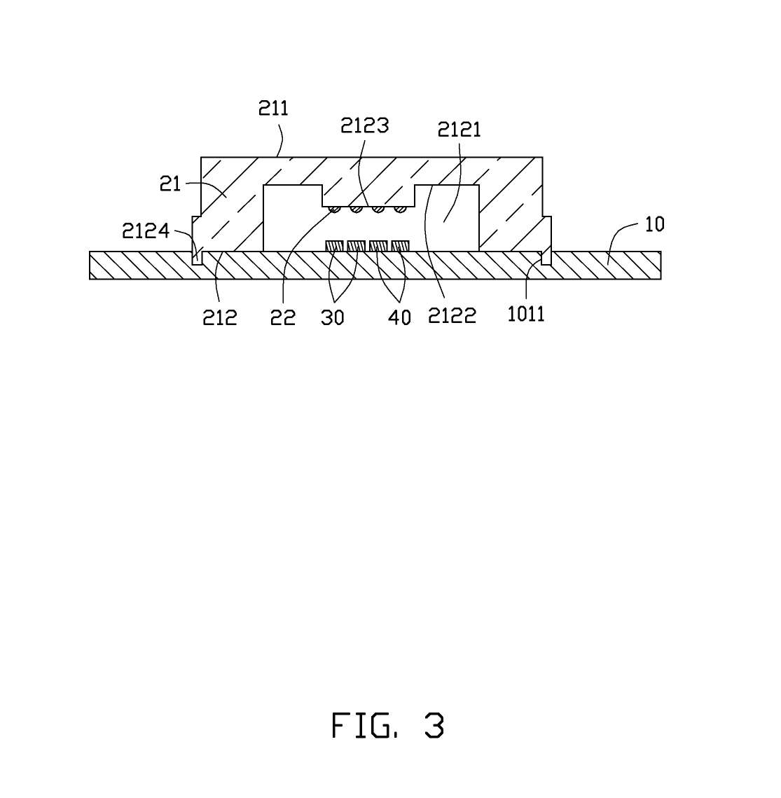

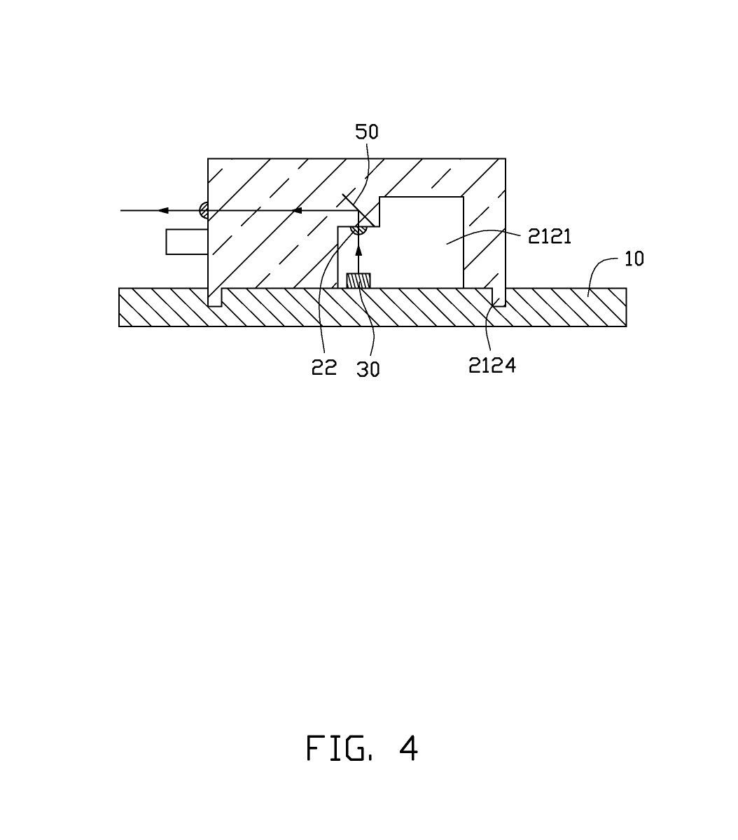

Also referring to FIGS. 3 and 4, the bottom surface 212 defines a substantially rectangular recess 2121. The recess 2121 includes a lower surface 2122 parallel to the bottom surface 212. A rectangular block 2123 extends up from the lower surface 2122. The at least two first lenses 22 extend up from the block 2123 toward the bottom surface 212. In the embodiment, the number of the first lenses 22 is four and the four first lenses 22 are distributed in a line. Each first lenses 22 is a convex lens. An alignment portion 2124 forms on the bottom surface 212. In the embodiment, the alignment portion 2124 is a closed rib extending along the periphery of the bottom surface 212. A shape of the closed rib 2124 is generally trapezoidal, which corresponds to the shape of the closed groove 1011. A shape of a cross plane of the closed rib 2124 perpendicular to the mounting surface 101 is also rectangular, corresponding to the shape of the cross plane of the closed groove 1011. The alignment portion 1011 of the circuit board 10 is configured to be engaged with the alignment portion 2124 of the shell 20.

In the embodiment, when the alignment portion 1011 of the circuit board 10 is engaged with the alignment portion 2124 of the shell 20, each of the light emitters 30 and the light receivers 40 is aligned with a respective first lens 22. In the embodiment, the two light emitters 30 are aligned with two of the first lenses 22, the two light receivers 40 are aligned with the other two first lenses 22.

The at least two second lenses 23 extend up from the side surface 213. In the embodiment, the number of the second lenses 23 is four and the four second lenses 23 are distributed in a line. Each second lenses 23 is a convex lens. An optical axis of each first lens 22 and an optical axis of a respective one of the second lens 23 are orthogonal to each other.

The number of the at least two reflecting elements 50 is four. Each reflecting element 50 is positioned between a light path between each first lens 22 and a respective one of the second lens 23. The optical axis of each first lens 22 and the optical axis of a respective one of the second lenses 23 are intersected at a respective reflecting element 50. Each reflecting element 50 is configured to reflect light beams from each first lens 22 to a respective one of the second lenses 23 or reflect light beams from each second lens 23 to a respective one of the first lenses 22.

When assembling the shell 20 to the circuit board 10, the alignment portion 2124 of the shell 20 is engaged with the alignment portion 1011 of the circuit board 10, namely the closed rib is received in the closed groove. As such, the shell 10 is mounted on the circuit board 10 and encloses the light emitters 30 and the light receivers 40. Each of the light emitters 30 and the light receivers 40 is aligned with a respective first lens 22. In use, each light emitter 30 emits a first light beams. The first light beams project into the shell 20 through a respective one of the first lens 22, then are reflected to a respective one of the second lenses 23, and finally emit out from the shell 20 through the respective one of the second lenses 23. A second light beams project into the shell 20 through a respective one of the second lenses 23. The second light beams are reflected to a respective one of the first lenses 22, emit out from the shell 20 through the respective one of the first lenses 22, and finally project to a respective one of the light receivers 30.

In alternative embodiments, adhesive can be utilized between the alignment portion 1011 of the circuit board 10 and the alignment portion 2124 of the shell 20, such that the shell 20 is more steadily mounted on the circuit board 10.

The alignment portion 1011 of the circuit board 10 is a closed groove and the alignment portion 2124 of the shell is a closed rib. Therefore, dust is prevented from entering the recess 2121 and contaminating the light emitters 20 and the light receivers 30 from outside. In alternative embodiments, the alignment portion 1011 of the circuit board 10 can be a closed rib, and the alignment portion 2124 of the shell 20 can be a closed groove.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An optical connector, comprising:
a circuit board comprising a mounting surface and a first alignment portion formed on the mounting surface;
at least one light emitter mounted on the mounting surface;
at least one light receiver mounted on the mounting surface; and
a transparent shell comprising at least two first lenses and a second alignment portion, the shell positioned on the circuit board and enclosing the at least one light emitter and the at least one light receiver therein;
wherein the first alignment portion of the circuit board is engaged with the second alignment portion of the shell, with each of the at least one light emitter and the at least one light receiver being optically aligned with a respective one of the at least two first lenses.

2. The optical connector of claim 1, wherein the first alignment portion of the circuit board is a closed groove surrounding the at least one light emitter and at least one light receiver, the second alignment portion of the shell is a closed rib, and the closed rib is received in the closed groove.

3. The optical connector of claim 2, wherein a shape of a cross plane of the closed groove perpendicular to the mounting surface is rectangular, and a shape of a cross plane of the closed rib perpendicular to the mounting surface corresponds to the shape of the cross plane of the closed groove.

4. The optical connector of claim 2, wherein the shell comprises a main portion, the main portion comprises a bottom surface, the closed rib extends up from the bottom surface along a periphery of the bottom surface.

5. The optical connector of claim 4, wherein the bottom surface defines a substantially rectangular recess, the recess comprises a lower surface parallel to the bottom surface, a cuboid block extends up from the lower surface toward the bottom surface, the at least two first lenses extend up from the block.

6. The optical connector of claim 4, wherein the shell further comprises a side surface perpendicular to the bottom surface and at least two second lenses extending from the side surface, an optical axis of each first lens and an optical axis of each second lens are orthogonal to each other.

7. The optical connector of claim 6, wherein the optical connector includes two light emitters, two light receivers, four first lenses, and four second lenses.

8. The optical connector of claim 1, wherein each light emitter is a laser diode, and each light receiver is a photodiode.

9. The optical connector of claim 1, wherein adhesive is utilized between the first alignment portion of the circuit board and the second alignment portion of the shell.

10. The optical connector of claim 1, wherein the first alignment portion of the circuit board is a closed rib surrounding the at least one light emitter and at least one light receiver, the second alignment portion of the shell is a closed groove, and the closed rib is received in the groove.

11. An optical connector, comprising:
a transparent shell comprising at least two first lenses and a first alignment portion;
a circuit board comprising a mounting surface and a second alignment portion formed on the mounting surface;
at least one light emitter mounted on the mounting surface; and
at least one light receiver mounted on the mounting surface;
wherein the second alignment portion of the circuit board is engaged with the first alignment portion of the shell, with each of the at least one light emitter and the at least one light receiver being optically aligned with a respective one of the at least two first lenses.

12. The optical connector of claim 11, wherein the second alignment portion of the circuit board is a closed groove surrounding the at least one light emitter and at least one light receiver, the first alignment portion of the shell is a closed rib, and the closed rib is received in the groove.

13. The optical connector of claim 11, wherein the second alignment portion of the circuit board is a closed rib surrounding the at least one light emitter and at least one light receiver, the first alignment portion of the shell is a closed groove, and the closed rib is received in the groove.
